(19) United States
(12) Patent Application Publication
(10) Pub. No.: US 2017/0248761 A1
(43) Pub. Date: Aug. 31, 2017

(54) NON-CONTACT OPTICAL FIBER CONNECTOR COMPONENT

(71) Applicant: Benjamin B. Jian, San Jose, CA (US)

(72) Inventor: Benjamin B. Jian, San Jose, CA (US)

(21) Appl. No.: 15/595,909

(22) Filed: May 15, 2017

Related U.S. Application Data
(63) Continuation of application No. 13/725,087, filed on Dec. 21, 2012.
(60) Provisional application No. 61/579,017, filed on Dec. 22, 2011.

(51) Int. Cl. G02B 6/38; G02B 6/25; G02B 6/255; G02B 6/44

(52) U.S. Cl. CPC G02B 6/3885; G02B 6/3881; G02B 6/4471; G02B 6/25; G02B 6/255; G02B 6/443; G02B 6/3882

(57) ABSTRACT

An optical fiber connector component that is useful for joining and connecting fiber cables, particularly in the field. A joinder component includes a fiber ferrule coaxially housing a short section of optical fiber with a rearward flanged sleeve that allows the fiber to extend through it. Rearwardly the flanged sleeve extends into a connector body where a fusion splice of the fiber section to the main fiber cable is hidden. Forwardly, the fiber facet and ferrule have anti-reflection coatings and are configured so that the fiber has an output facet recessed slightly relative to the forward polished end surface of the ferrule so that when two ferrule end surfaces are brought together in an adapter, respective fiber facets are slightly spaced apart thereby avoiding wear on fiber facets due to physical contact, yet having good optical communication.

### CROSS-REFERENCE TO RELATED APPLICATION

This application claims priority as a continuation of U.S. patent application Ser. No. 13/725,087, filed on Dec. 21, 2012, which claims priority from provisional application Ser. No. 61/579,017, entitled “Non-Contact Optical Fiber Connector”, and filed on Dec. 22, 2011, the disclosures of which are incorporated by reference herein.

### TECHNICAL FIELD

The present invention relates to fiber optic connectors in general and in particular to a connector component useful for terminating optical fibers for joinder of optical fiber cables, and the like, in a fiber connector.

### BACKGROUND ART

In fiber optics based communication systems, it is necessary to have optical fiber connectors with low transmission loss and low back reflection from the fiber to fiber interface. There are two types of optical fiber connectors in general, one type is the predominant fiber connector based on physical contact and we call it “conventional” fiber connector in this application and the other type is called expanded beam connector which utilizes a lens, and is used only in limited applications.

The conventional connector designs were developed in the 1980s with an eye toward simplicity and ease of implementation. Indeed, the simplest way to ensure that there is no air gap between two fiber facets is to eliminate it through intimate physical contact. The advantages of this approach included low cost manufacturing and the ability to create connector terminations in the field, where installation occurs. Since the performance of the conventional connector was sufficient for most purposes, it is no surprise that it quickly became the standard for the fiber optics industry and has remained so for the past three decades. In fact, the physical contact mechanism worked so well, most researchers of optical fiber connectors did not realize that there could be another physical mechanism to make fiber connectors.

There are two main types of conventional connectors: one type has zero-degree polish angle and is called PC (physical contact) connector, the other type is called APC (angled physical contact) connector which typically has an 8-degree tilted polish angle at the fiber facet in order to minimize back reflection. PC connectors are used in places where significant back reflection can be tolerated, and APC connectors-are used where minimum back reflection is required. To ensure reliable physical contact between the fibers, both PC and APC connectors have rounded, i.e., convex, connector surfaces such that the fiber cores touch first.

While PC and APC connectors have the significant advantage of easy fiber termination by polishing, the weaknesses of this approach are readily apparent. For example, contamination between the fibers can easily disrupt the coupling of the light by creating an air gap and particulates can prevent physical contact altogether, leading to poor, unpredictable performance In addition, as with any apparatus involving physical contact, repeated coupling of the connectors causes wear and tear, which invariably degrades optical performance over time. In fact, typical conventional fiber connectors have a rated life of 500-1000 mating cycles.

APC connectors have another significant weakness. The angled facet produces an additional requirement of rotational alignment, which is achieved by means of a key which sets the mating angle within some degree of tolerance. If this angle is not sufficiently precise, an air gap will open between the fibers, leading to significant optical loss due to Fresnel reflection. While the rounded connector facets relax the required angular precision, it is difficult in practice to ensure that the fiber is at the apex of the polish surface, thereby reducing the achievable alignment. It is generally known that APC connectors have inferior optical performance in insertion loss compared to PC connectors. Random mating performance is much worse for APC connectors.

Published U.S. application 2011/0262076 to Hall et al. recognizes that optical fibers may be terminated by being recessed from the front-end face of a ferrule by a suitable distance to inhibit physical contact of the fiber with another fiber when mated in a complementary connector. However, there can be multiple reflections and interference at the two glass surfaces which tend to make the optical transmission unstable.

For applications in which harsh conditions require a more robust solution, the expanded beam connector was developed. In this approach, the divergent fiber output is collimated by a lens and travels as an expanded beam to an opposing lens and fiber assembly where it is refocused into the mating fiber. Dust, dirt and debris in the expanded optical path now scatter a much smaller fraction of the beam and therefore cause smaller coupling variation Similarly, this design is much more tolerant to vibration and shock. The drawback to this approach is inferior optical performance in terms of insertion loss and return loss, and significantly higher complexity and manufacturing cost, all as results of significantly increased number of optical elements. Thus, the benefits come at significantly higher cost.

An objective of the invention was to devise an optical fiber connector that has very long mating life, very stable and predictable transmission, insensitive to dirt and contaminant, has guaranteed random mating performance, and low manufacturing cost.

Another objective of the invention was to devise an optical fiber connector that preserves most of the advantages of the expanded beam connectors while doing away with disadvantages.

### SUMMARY OF THE INVENTION

The above objective has been met with a non-contact (“NC”) optical fiber connector that terminates a fiber optical cable and is intended to reside in a connector adapter joining optical fiber cables.

Each such fiber terminates at an output facet. A tubular ferrule having an output end and a junction end coaxially surrounds the fiber. The fiber output facet has a concave offset relative to the surrounding endwise surface of the ferrule, such that when two aligned abutting ferrules of a fiber coupling device are mutually facing and in contact, a small gap of micron level is present between the fiber facets. The endwise surface of the ferrule is preferably convex. The gap is sufficiently small so as to allow the light to couple easily between the fiber cores for optical communication. To substantially eliminate the transmission loss at air-fiber interfaces, the fiber facets are coated with a durable anti-reflection (“AR”) coating. The means for providing the concave offset can be either an indentation of the fiber relative to the endwise surface of the ferrule or, alternating, a built-up spacer on the endwise surface of the ferrule relative to the fiber facet, such as by an annular metal deposit.

In a preferred embodiment, the fiber inside the AR coated fiber ferrule is bare fiber and therefore causes minimal outgassing in a vacuum AR coating chamber and permits very large number of such ferrules to be coated simultaneously, thereby reducing the AR coating cost for each ferrule assembly. The rear end of the fiber at the above AR coated connector ferrule can be cleaved, and fusion spliced to a typically reinforced fiber cable, as in known splice-on connectors.

Advantages of the NC coupling device include excellent optical performance in insertion loss and return loss, excellent mating repeatability, greater predictability, and long service life over repeated couplings. The design is inherently more tolerant of particulates and contamination at the interface and thus more user-friendly. It is field installable by fusion splicing to a long cable. Finally, it is expected that the present invention may be produced at only slightly higher cost than conventional fiber connectors, and at much lower cost than the expanded beam connector solution.

### DESCRIPTION OF THE DRAWINGS

FIG. 1 is a cross sectional view showing a preferred embodiment of the non-contact optical fiber connector component according to the present invention.

FIG. 2 shows a pair of such non-contact fiber connector components as shown in FIG. 1 mated together.

FIGS. 3(A) and 3(B) are contour plots of the recessed fiber surfaces of the non-contact optical fiber connector, as measured by a commercial fiber optic interferometer.

FIG. 4 is a cross sectional view showing another embodiment of the non-contact optical fiber connector component according to the present invention.

FIG. 5 is a schematic drawing of a generic non-contact optical fiber connector with a splice-on connector construction.

FIG. 6 is a schematic drawing of a sample holder for AR coating many non-contact fiber connector components of the type in FIG. 1 simultaneously.

FIG. 7 is a plan view of a non-contact multi-fiber connector pair according to an embodiment of this invention.

### DETAILED DESCRIPTION

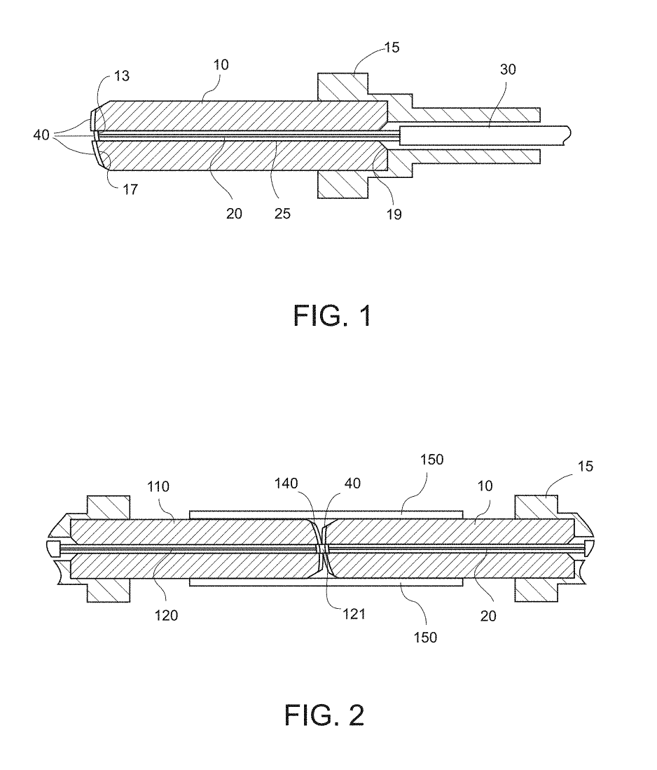

With reference to FIG. 1, an embodiment of the non-contact optical fiber connector component according to the present invention is a non-contact fiber ferrule assembly for making non-contact optical fiber connectors. An optical fiber 20 is permanently affixed in the axial through hole 25 of a connector ferrule 10 with epoxy, and a metal flange 15 is connected to the ferrule 10. The front surface of the ferrule 17 forms a smooth polished, curved profile with the fiber surface 13 somewhat offset from surface 17. An AR coating 40 is applied over the entire polished surface of the ferrule 17 and the fiber facet 13. The fiber 20 can be any type of optical fiber. For example, it can be single mode fiber, multimode fiber, or polarization maintaining fiber.

FIG. 2 shows a pair of such non-contact fiber connector components coupled together to complete a fiber connection with the aid of an alignment split sleeve 150 found in a connector adapter. A conventional fiber connector adapter is used to align the two non-contact fiber connectors. The two ferrules 10 and 110 are shown precisely aligned by a split sleeve 150 which sits at the center of a fiber connector adapter. A first fiber 20 communicates light to a second fiber 120 through a gap 121 that exists between the two fibers by virtue of the fibers being slightly recessed. Thus, while the AR coatings 40 and 140 on the front surfaces of ferrules 10 and 110 are in contact, the AR coatings on the fiber facets are not in contact. As seen in FIG. 2, the portion of the ferrule 10 with the AR coating 40 immediately adjacent fiber 20 contacts the portion of the ferrule 110 with the AR coating 140 immediately adjacent fiber 120. Therefore, this fiber optic connector is called a non-contact connector.

We now describe the non-contact fiber connector component in FIG. 1 in more detail, in the order of the manufacturing sequence. The non-contact optical fiber connector component of FIG. 1 includes a ferrule 10 that is a conventional connector ceramic ferrule, typically a zirconia ceramic tube having a standard length and diameter. Most often the ferrule 10 has a length on the order of 0.5 to 1.3 cm, and the diameter may be 2.5 mm or 1.25 mm. The ferrule 10 has a polished front end 17 and a rear end 19. In turn, the rearward portion of ferrule 10 is connected to a metal flange sleeve 15, being permanently affixed to ferrule 10 with a tight press fit. Glass fiber 20 is inserted into the coaxial ferrule inner hole 25 and permanently affixed by epoxy (not shown). Protected fiber cable 30 is rearward of the ferrule 10.

The fiber ferrule assemblies are then polished at the light output end so as to render a smooth surface 17 on the ferrule 10. The polish angle, measured as tilt from vertical at the fiber core, where vertical is perpendicular to the fiber axis, can be zero degrees, or non-zero degrees to minimize back reflection. In a preferred embodiment, the polish angle is 8 degrees. Just as in conventional fiber connectors where the connector ferrule surface is a convex surface, ferrule front surface 17 should be convex as well.

### Differential Polishing

The polishing process for non-contact fiber connectors in this invention is very similar to conventional connector polishing, except the final polishing step. After a fiber stub removal step, a series of progressively finer lapping films are used to polish the connector surface, typically from 9 micron, 3 micron, to 1 micron diamond particles. Final polish step is then performed.

The final polishing step in this invention is different from conventional connector polishing, and is the step responsible for forming the recess in the fiber. In this step, the fiber is preferentially and differentially polished relative to the ferrule front surface so as to create a recess between the fiber facet 13 and ferrule front face 17. The recess range should be kept as small as possible to reduce optical coupling loss, while ensuring no physical contact between the opposing fiber facets when mated.

For a single mode fiber SMF-28, the light beam is best described as a Gaussian beam. In air, the working distance (Rayleigh range) is about 100 microns. If the fiber recess is 0.5 micron, light from the fiber core traveling twice the recess length does not expand sufficiently to induce significant optical coupling loss. The extent of a recess is preferably in the range of 0.1 microns to several microns.

The recessed fiber facet 13 in FIG. 1 can be created by polishing with flocked lapping films. These are lapping films with micro brushes which have abrasive particles embedded in them. For example, 3M flocked lapping film 591 can be used to create this recess. This is a lapping film with micro brushes which have 0.5 micron cerium oxide particles embedded in. Cerium oxide has a hardness very similar to that of the optical fiber but much softer than the zirconia ceramic ferrule 10, and as a result, only the fiber surface 13 is polished in this step. This step generates a very smooth optical fiber surface and typically is the last polishing step. The time in the final polishing step varies, and can be as short as 20 seconds. Polishing pressure in this final step should be kept lower than the previous polishing steps, in order to extend the lifetime of the flocked lapping film. Flocked lapping films with other polishing particles can be used as well, such as aluminum oxide or silicon nitride.

Finally, an AR coating 40 is applied to the polished surface of the fiber 13 and front surface of the ferrule 17. The operating wavelength range of the AR coating determines the operating wavelength range of the non-contact optical fiber connector in this invention.

In a preferred embodiment, many polished fiber ferrule assemblies are loaded into a vacuum coating chamber and coated with a multi-layer stack of dielectric materials. Numerous AR coating processes can be used. For example, the coating method can be ion beam sputtering or ion-assisted e-beam deposition. Care should be taken to prevent significant amount of the coating material from getting on the sidewall of the ferrule cylindrical surface, by suitable masking. Otherwise the material will alter the precision diameter of the ferrule, and cause flaking off of coating material which will affect connector performance.

The fiber cables to be coated in an AR coating chamber must not outgas significantly in a vacuum chamber. We have observed that the inclusion of a mere ten 0.9 mm loose-tube buffered cables in the chamber can lengthen the vacuum pumping time from 2 hours to more than ten hours for ion beam sputtering. The materials of the fiber cable must be chosen carefully to reduce outgassing. Bare fibers housed in ferrules in the AR coating chamber are optimal.

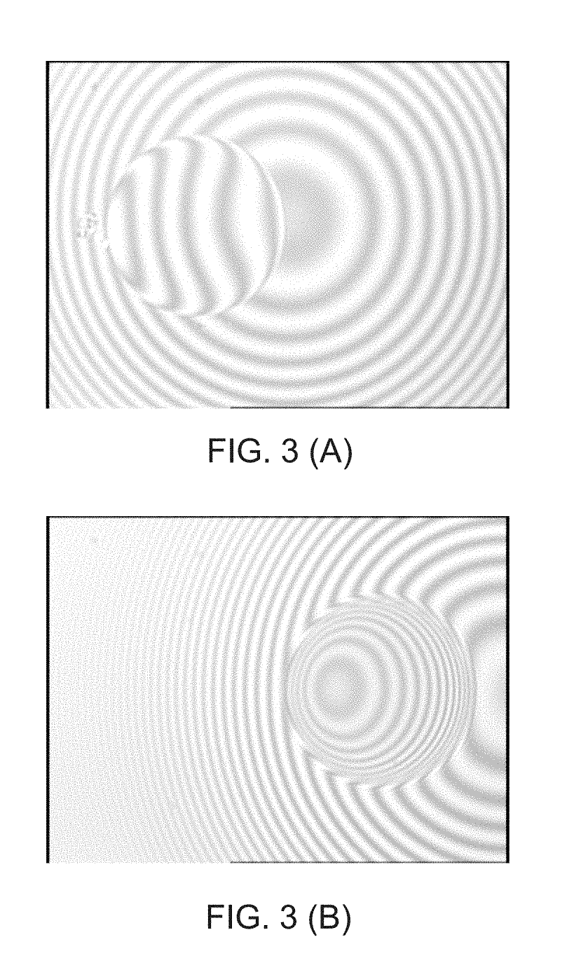

FIGS. 3(A) and 3(B) are contour plots of the recessed fiber surfaces of the non-contact fiber connector, polished by a 0.5 micron cerium oxide flocked lapping film, as measured by a commercial fiber optic interferometer. To show the recessed fiber surface, the connector surface was tilted intentionally in order to show continuous height contours. Different amounts of polishing time were used in these two cases. The depth of fiber recess in the plots was estimated to be 0.5 micron and 2.8 micron respectively. Some curvature on the fiber surface center can be seen from these two plots, but the amount of curvature is not large enough to significantly alter light beam propagation between the recessed fiber facets.

We have polished more than 500 non-contact fiber connectors with zero scratches, which is very different from the final polish step of conventional connectors where scratches are frequent and inspection and repolishing are required. As a result, 100% inspection of connector polishing after final polish step becomes unnecessary which can save significant manual labor cost.

### Non-Contact Fiber Connector Performance

Several hundred non-contact fiber connectors with recessed fiber facets have been made to date with great manufacturing yield. Both zero degree and 8° angled non-contact (ANC) single mode fiber connectors were made.

The insertion loss of both zero degree and 8° ANC connectors shows nearly identical loss distribution to that of conventional fiber connectors. The insertion loss in all three cases is dominated by the errors in the fiber core positions due to geometrical tolerances.

A mated pair of zero degree NC connectors has about 30 dB return loss, while a mated pair of 8 degree ANC connectors has more than 70 dB return loss, or about 10 dB higher return loss than conventional 8 degree APC connectors.

Both NC and ANC connectors have essentially guaranteed insertion loss performance in random mating. Therefore, an ANC connector is the preferred connector because it has superior return loss performance.

We have tested a pair of ANC connectors and found it lasted through 10,000 matings with less than 0.01 dB insertion loss change from the beginning of the test to the end.

The non-contact fiber connector of the type shown in FIG. 1 greatly improves the optical performance and the durability of the fiber connector and meets the needs of most applications.

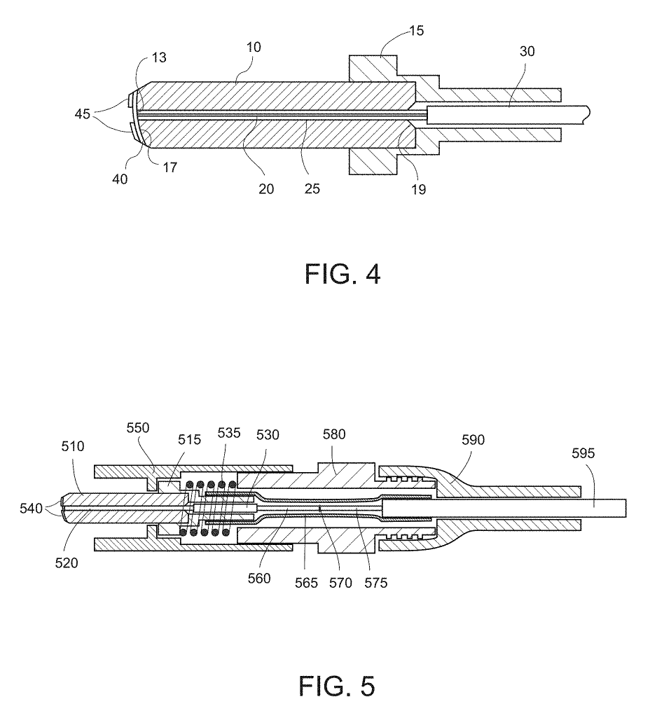

FIG. 4 is a cross sectional view showing another embodiment of the non-contact optical fiber connector component according to the present invention. Another means for providing a recess of the fiber facet relative to the ferrule front surface is to coat the ferrule surface selectively with a metal coating 45 as a spacer layer on top of the AR coating layer 40. Metal coatings having a thickness of from a fraction of a micron to a few microns may be applied by vapor deposition or ion beam sputtering using techniques known in the semiconductor industry. Such coatings are known to be resistant to wear and tear.

In this embodiment, the fiber ferrule assembly can be polished using a conventional connector polishing process. The result of this polishing process is that the fiber is at the apex of the convex surface. The polishing angle can be zero degrees or 8 degrees. The metal coating can be accomplished by a suitable masking operation so that the metal does not cover the fiber surface. Note that the AR coating 40 covers both the output facet 13 of the fiber 20 and the front surface 17 of ferrule 10.

In conventional connector cables, frequently a long length of reinforced fiber cable is used between two optical fiber connectors. For example, one of the most used fiber cable is a 3 mm diameter cable with Kevlar fabric reinforcement. Such a cable will outgas greatly in a vacuum chamber, occupy too much room and difficult to manage inside the AR coating chamber. Clearly AR coating entire fiber connector cables in an AR coating chamber is not an option.

Instead, only the most essential part of the connector with very short length fiber should be loaded in. After AR coating, such short fiber should be connected to the long, reinforced cable by fusion splicing, which is a very reliable and relatively low cost fiber connection method.

Splice-on connectors are known in the prior art. These are conventional connectors that have factory-polished connector surfaces with a short length of cleaved fiber at the rear of the connector head ready for fusion splicing to a long length of typically reinforced fiber cable.

FIG. 5 is a schematic drawing of a generic non-contact optical fiber connector with a splice-on connector construction. This construction is a necessary part of the low-cost mass production process, because it allows non-contact fiber connectors to have very long fiber cables and reinforced fiber cables. The splice-on structure of the coupling device also allows non-contact fiber connectors to be installed in the field.

In FIG. 5, a non-contact fiber ferrule assembly is housed in a connector structure, which comprises a housing 550, a spring 535, a main body 580, a rubber boot 590. The spring 535 provides positive force to the fiber ferrule 510, which has a fiber 520 inside its through hole. An AR coating 540 is at the front surface of the fiber ferrule assembly and covers the fiber facet. The fiber at the rear of the fiber ferrule 510 has a protected bare fiber section 530. It is stripped and cleaved to expose a glass fiber section 560. A long fiber cable 595 is stripped and cleaved to expose a glass fiber section 575. These two glass fiber sections are fusion spliced together at fusion splicing joint 570. The glass fiber sections should be as short as possible, so that the splice-on connector is not too bulky. Each glass fiber section is preferably 5 mm in length. Because the fusion spliced joint is very weak, it is reinforced by a conventional fusion splicing protection sleeve 565, which is attached at one end of the metal flange 515 and at the other end to long cable 595. There is a steel rod inside the protection sleeve to give it strength.

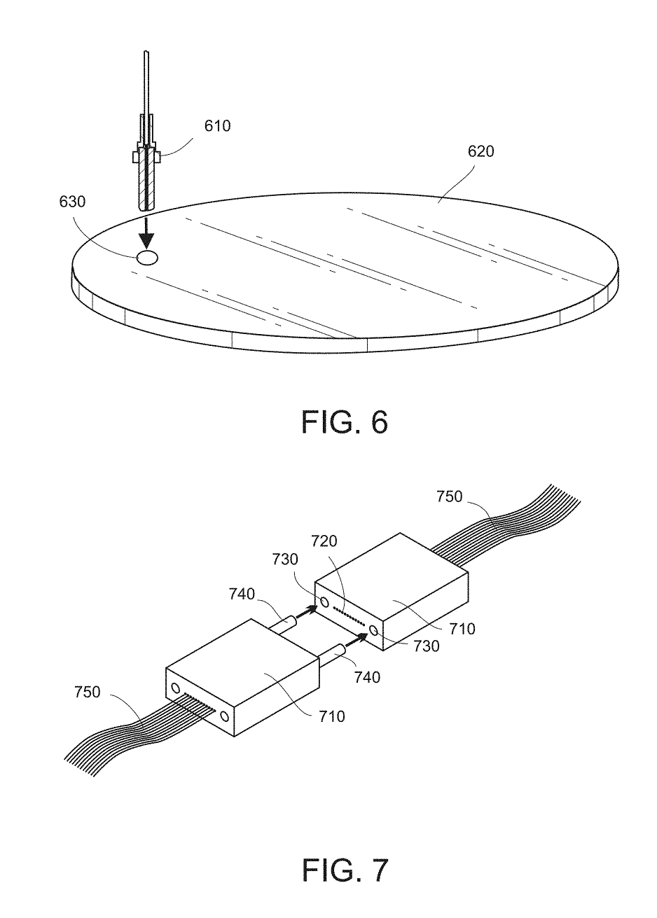

FIG. 6 is a schematic drawing of a sample holder 620 for AR coating a very large number of fiber ferrule assemblies simultaneously. The holder 620 is machined with many closely spaced, ferrule sized holes 630 so that a large number of fully polished fiber ferrule assemblies 610 of the type depicted in FIG. 1, without the AR coating, may fit in. Thousands of such assemblies can be AR coated in the same coating run using such a holder 620 to reduce manufacturing cost.

The non-contact fiber connector operating principle established above can be used for multi-fiber connectors as well, such as MT type array connectors.

FIG. 7 is a plan view of a non-contact multi-fiber connector pair according to an embodiment of this invention. A plurality of optical fibers 750 are permanently affixed in the axial through holes of the multi-fiber connector ferrule block 710 with epoxy. The front surface of the ferrule block 710 forms a smooth polished profile with the fiber facets 720 recessed. An AR coating is applied over the entire polished front surface of the ferrule block 710 and the fiber facets 720.

When a multi-fiber connection is made using two non-contact multi-fiber connectors as in FIG. 7, two guide pins 740 go through one ferrule block 710 and enter the precisely formed guide holes 730 of the opposing ferrule block to align the two multi-fiber connectors. The polished front surfaces of the two multi-fiber connectors that surround the optical fibers 750 positioned in the axial through holes must make contact due to the springs in the connectors (not shown). A latch, not shown, holds the two ferrule blocks 710 together. Due to the fiber facets being recessed, the fiber facets do not touch, resulting in reliable and long lasting operation of the non-contact multi-fiber connector.

Fiber facets 720 can be offset from ferrule block front surface by a number of means. Selective etching, differential polishing, metal deposition, or simply deforming the polished ferrule surface can all achieve non-contact of fiber facets. In all cases, small gaps between facing fibers can communicate optical signals from fiber cables to mating cables. The facets can have a slight angle, say 8 degrees.

1. A multi-fiber optical connection between single mode optical fibers comprising:
a first ferrule block having a first front surface, the first ferrule block adjacently surrounding a plurality of first fiber alignment holes within the first ferrule block;
a plurality of first single mode optical fibers, each first fiber being situated in respective first fiber alignment holes and terminating with a fiber facet recessed from the first front surface of the first ferrule block at a distance of approximately 0.1 micron to several microns;
an anti-reflection coating overlaying each first fiber facet and the front surface of the first ferrule block;
a second ferrule block having a second front surface, the second ferrule block adjacently surrounding a plurality of second fiber alignment holes within the second ferrule block;
a plurality of second single mode optical fibers, each second fiber being situated in respective second fiber alignment holes;
wherein the front surface of the first ferrule block contacts the front surface of the second ferrule block when the first ferrule block is mated to the second ferrule block, the contact portions of the first and second ferrule blocks being immediately adjacent and surrounding the respective first and second single mode optical fibers.

2. The multi-fiber optical connection of claim 1 further comprising a deposit on the first ferrule block.

3. The multi-fiber optical connection of claim 2 wherein the deposit on the first ferrule block is a metal deposit.

4. The multi-fiber optical connection of claim 1 wherein said plurality of optical fibers has an axis, with the fiber facet of at least one of the plurality of optical fibers being substantially non-perpendicular to said fiber axis.

5. The multi-fiber optical connection of claim 1 further comprising at least two apertures in said first ferrule block and at least two guide pins in the second ferrule block for aligning the first ferrule block with the second ferrule block.

6. The multi-fiber optical connection of claim 1 further comprising fusion splices in at least the first single mode optical fibers distal to the first fiber facets.
